(19) United States
(12) Patent Application Publication
(10) Pub. No.: US 2026/0361636 A1
(43) Pub. Date: Nov. 12, 2026

(54) System and method for predicting and remedying network dependency anomalies

(71) Applicant: Bank of America Corporation, Charlotte, NC (US)

(72) Inventors: Vishal Bipinchandra Malaviya, Singapore (SG); Sandeep Kumar Chauhan, Madinaguda (IN)

(21) Appl. No.: 19/199,540

(22) Filed: May 6, 2025

(51) Int. Cl. H04L 43/50; G06F 11/07; H04L 43/16

(52) U.S. Cl. CPC H04L 43/50; G06F 11/079; H04L 43/16

(57) ABSTRACT

A system for predicting and remedying network dependency anomalies includes a memory operably coupled with a processor. The system determines a modification performed on the source device based on monitoring the source device. The modification performed on the source device includes the installation of a new software application on the source device. The system predicts potential performance issues associated with the operations performed by a first upstream device and a first downstream device in response to analyzing the network parameters. The system determines remedies to address the potential performance issues associated with the first upstream device and the first downstream device in response to predicting the potential performance issues associated with the first upstream device and the first downstream device.

### TECHNICAL FIELD

The present disclosure relates generally to remedying network dependency anomalies and, more specifically, to a system and method for predicting and remedying network dependency anomalies.

### BACKGROUND

In a network environment, an organizational resource (e.g., a source device) of an organizational network communicates with other internal organizational resources. These other internal organizational resources may include upstream devices and/or downstream devices that exchange information with the source device. For example, the source device may be a server device, and the upstream and downstream devices may be other server devices or databases. One of the technical challenges that occur while exchanging information among organizational resources is when a change is performed (e.g., adding a new software application or updating a software code) at the source device. In some cases, the change (e.g., the new software application or the updated software code) may increase the server load capacity associated with the upstream devices and/or downstream devices. This increase in server load capacity may cause anomalies in the operations associated with the upstream devices and/or downstream devices. Such anomalies may include a breakdown of the upstream devices and/or downstream devices and, in some cases, may lead to complete failure of the organizational network.

### SUMMARY

The disclosed system, described in the present disclosure, is particularly integrated into a practical application of network communication between source devices, upstream devices, and downstream devices within an organizational network to remedy network dependency anomalies. This practical application provides several technical advantages, including providing an anomaly evaluation device and an AI agent to monitor source device to determine when a change is performed within an organizational network. In response to determining that a change is performed at the source device (e.g., server device), the system is able to identify upstream devices and downstream devices (e.g., other server devices and/or databases) that depend on the source device to perform their operations. The source devices, the upstream devices, and the downstream devices together form part of the organizational resources. Further, the system then predicts potential performance issues associated with the operations performed by the identified upstream devices and downstream devices. The system then determines remedies and executes the remedies to address the predicted potential performance issues. This results in avoiding a breakdown of operations associated with the upstream devices and downstream devices caused by an increase in server load capacity because of installing the new software application at the source device or by updating software code (e.g., a software patch) that is incompatible with the upstream devices and downstream devices. The organizational resources of the present disclosure include hardware, such as mainframes, servers, databases, networking equipment, computers, mobile devices, memory devices, and the like; software that is executed by the hardware; and/or information stored or operated upon by the hardware or software.

Conventional technologies are not configured to provide reliable network communications between the organizational resources of an organization network. One of the technical challenges that occur with updating a software code (e.g., a software patch) at a source device that is incompatible with the upstream devices and downstream devices may result in the operations of the upstream devices and downstream devices to break down. For example, the operations associated with the upstream devices and downstream devices may include, for example, batch-processing jobs to read and write data. When the upstream devices and downstream devices break down, it may result in a failure to execute the batch processing jobs. Further, certain other computing systems may rely on the batch processing jobs to be executed. In such a situation, since the batch processing jobs are not executed, this may result in system damage (e.g., compromised computing performance, device failure, etc.) to those other computing systems in communication with the upstream devices and downstream devices. To remedy such harmful actions (i.e., system damage), the affected computing systems must be taken offline until the root problem is identified, thus making it inaccessible until the problem is identified and remedied. When a computing system is taken offline, it may further cause the computing systems to shut down or go offline and thus be unavailable to provide services. This results in, for example, under-utilization of the affected computing systems, resulting in reduced performance of the network. In a situation where multiple computing systems may go offline; it may result in disruption of network operations across the organizational network. In some cases, the disruption of network operations across the organizational network is often associated with unnecessary data redundancy and thus reduces the overall network performance. Further, when multiple computing systems go out of service, it results in system downtime and the unavailability of system processes and information.

Another one of the technical challenges that occur with installing the new software application at the source device may inadvertently increase the server load capacity associated with the upstream devices and/or downstream devices. This increase in server load capacity may cause degradation and/or network outages in the organizational network. The increase in server load capacity leads to network resource depletion, which increases network latency associated with performing, for example, network operations associated with the upstream devices and/or downstream devices. This increase in network latency associated with operations results in the slower processing of network operations, resulting in network traffic bottlenecks. Network traffic bottlenecks may result in the queuing of operations in an operations queue, which can have several negative effects on overall network performance. For example, when each operation in an operations queue takes longer to complete due to high latency, the total time required to process all the operations within the operations queue increases. This directly affects the network's ability to process and transfer data efficiently, leading to slower overall system performance. Higher latency reduces throughput, which is the amount of data transmitted across the network in a given time period. This occurs because each operation takes longer to complete, resulting in fewer tasks being processed in the same amount of time. Higher latency associated with performing the operations also results in inefficient use of computing resources in the network. For example, high latency can lead to inefficient use of network resources. For instance, when high latency delays the execution time of operations, systems may remain idle while waiting for responses, leading to poor utilization of resources like CPU, memory, and bandwidth. In addition, when operations with high latency stack up or accumulate due to delays, they can create queues at intermediate network devices like routers, switches, and firewalls. This results in breakdown of operations and congestion of the network, thus lowering the performance of devices (i.e., the upstream devices and downstream devices) within the organizational network. Also, when latency increases, applications and servers may be forced to wait longer for responses from external systems. This added delay can lead to increased load on the system, as operations back up while waiting for network responses, reducing the efficiency and performance of the organizational network.

In some embodiments, a system for predicting and remedying network dependency anomalies includes a memory operably coupled with a processor. The memory is configured to store an artificial intelligence (AI) agent and an architecture information repository. The architecture information repository stores dependency information associated with one or more upstream devices and one or more downstream devices corresponding with a source device. The processor is configured to collect a first data set comprising known potential performance issues, unknown potential performance issues, and known remedies associated with the corresponding known potential performance issues stored in the memory. The processor is further configured to create a modified first data set by annotating each of the known potential performance issues, wherein the annotations indicate a known remedy associated with the known potential performance issue. The processor is further configured to create a first training set comprising the first data set and the modified first data set and train the AI algorithm in a first stage using the first training set. The processor is further configured to create a second training set for a second stage of training. The second training set comprises the first training set and incorrectly determined known potential performance issues corresponding to known remedies. The processor is further configured to retrain the AI algorithm in a second stage using the second training set, to generate an AI agent. The processor is further configured to electronically receive a source device modification alert from a first instance of the AI agent installed at the source device. The first instance of the AI agent is configured to monitor the source device for any modifications performed on the source device and wherein the source device modification alert indicates an installation of a new software application on the source device. The processor is further configured to execute the AI agent to in response to receiving a source device modification alert. The processor executes the AI agent to identify the one or more upstream devices and the one or more downstream devices that depend on the new software application installed on the source device to perform their operations. The one or more upstream devices and the one or more downstream devices are identified based at least in part upon accessing the architecture information repository that stores the dependency information associated with the one or more upstream devices and the one or more downstream devices corresponding with the source device. The processor executes the AI agent to analyze one or more network parameters associated with the one or more upstream devices and the one or more downstream devices. The processor executes the AI agent to predict one or more potential performance issues associated with the operations performed by a first upstream device of the one or more upstream devices and a first downstream device of the one or more downstream devices in response to analyzing the one or more network parameters. The one or more potential performance issues includes unable to perform the operations associated with the first upstream device and the first downstream device. The processor executes the AI agent to determine one or more remedies to address the one or more potential performance issues associated with the first upstream device and the first downstream device in response to predicting the one or more potential performance issues associated with the first upstream device and the first downstream device. The processor executes the AI agent to dynamically execute the one or more remedies to address the one or more potential performance issues associated with the first upstream device and the first downstream device.

In some embodiments, a system for predicting and remedying network dependency anomalies includes a memory operably coupled with a processor. The memory is configured to store an architecture information repository. The architecture information repository stores dependency information associated with one or more upstream devices and one or more downstream devices corresponding with a source device. The processor is configured to determine a modification performed on the source device based on monitoring the source device. The modification performed on the source device includes an installation of a new software application on the source device. The processor is configured to identify the one or more upstream devices and the one or more downstream devices that depend on the new software application installed on the source device to perform their operations in response to determining the modification performed on the source device. The one or more upstream devices and the one or more downstream devices are identified based at least in part upon accessing the architecture information repository that stores the dependency information associated with the one or more upstream devices and the one or more downstream devices corresponding with the source device.

The processor is further configured to analyze one or more network parameters associated with the one or more upstream devices and the one or more downstream devices. The processor is further configured to predict one or more potential performance issues associated with the operations performed by a first upstream device of the one or more upstream devices and a first downstream device of the one or more downstream devices in response to analyzing the one or more network parameters. The one or more potential performance issues includes unable to perform the operations associated with the first upstream device and the first downstream device. The processor is further configured to determine one or more remedies to address the one or more potential performance issues associated with the first upstream device and the first downstream device in response to predicting the one or more potential performance issues associated with the first upstream device and the first downstream device. The processor is further configured to dynamically execute the one or more remedies to address the one or more potential performance issues associated with the first upstream device and the first downstream device.

Thus, unlike conventional systems that are not configured to provide reliable network communications between the organizational resources of an organization network, the disclosed system and methods predict potential performance issues associated with the operations performed by the identified upstream devices and downstream devices. The system then determines remedies and executes the remedies to address the predicted potential performance issues. This results in avoiding a breakdown of operations associated with the upstream devices and downstream devices caused by an increase in server load capacity because of installing the new software application at the source device or by updating software code (e.g., a software patch) that is incompatible with the upstream devices and downstream devices. As explained above, when upstream devices and downstream devices break down, it may cause system damage to those other computing systems in communication with the upstream devices and downstream devices. To address such harmful actions (i.e., system damage), the affected computing systems must be taken offline until the root problem is identified, thus making it inaccessible until the problem is identified and remedied. When a computing system is taken offline, it may further cause the computing systems to shut down or go offline and thus be unavailable to provide services. This leads to increased system downtime and further requires additional resources to remediate the offline computing systems, interrupting other operations that utilize the additional resources.

Other technical benefits include minimizing system downtime due to incompatible software patches and enabling faster and more effective remediation of potential performance issues. These benefits lead to additional technical benefits such as enhanced network resilience, increased operational continuity, and faster recovery times. By proactively identifying and addressing potential performance issues (e.g., incompatible software patches) leads to minimizing system downtime and strengthens the overall stability and reliability of the system, reducing the likelihood of unexpected outages. Effective monitoring and rapid response mechanisms allow for quicker restoration of system functionality in case of failures, minimizing the impact of any downtime that does occur. Reduced downtime also helps prevent data loss by ensuring consistent system operation and reducing the risk of corruption during unexpected outages. Monitoring system performance during uptime enables identification of bottlenecks and potential issues, allowing for proactive optimization and improved overall system efficiency. With a robust system that minimizes downtime, entities can more easily scale operations and adapt to changing demands without significant disruptions.

Avoiding the breakdown of operations allows the execution of batch jobs, thereby reducing or preventing system damage from occurring. The system thus mitigates the above-described harmful actions that may otherwise occur to the other organizational resources in communication with the server device, thus saving downtime associated with affected upstream devices and downstream devices and additionally saving resources that would otherwise be necessary to remediate affected upstream devices and downstream devices, which in turn provides uninterrupted operations of the organizational network. This leads to improved operational efficiency of computing systems because the computing systems are not required to be taken offline for remediation.

Additionally, by predicting potential performance issues and executing remedies to address the predicted potential performance issues before the performance of the upstream devices and downstream devices are affected by the installation of the new software application at the source device, this avoids increasing network latency associated with operations of the organizational network. Lowering latency associated with performing operations in the organizational network can improve network performance and computing performance in several ways and result in several technical advantages. For example, lower latency means operations associated with the organizational resources are completed more quickly. This results in faster processing and data exchange across the organizational network. Lower latency increases throughput of the organizational network and the organizational resources connected to the organizational network. Since each operation in a sequence takes less time to complete, more operations can be processed in the same amount of time, resulting in higher throughput. With reduced latency, organizational resources (e.g., servers) are used more efficiently. Servers spend less time waiting for responses from other systems and can focus on processing operations more rapidly, leading to better resource utilization. Lower latency also reduces the time spent waiting in queues for resources or data. This minimizes the chance of congestion or backlogs at network devices (e.g., routers, switches) or servers. As a result, data flows more freely through the organizational network. In addition, reducing latency helps optimize bandwidth by allowing data to flow more efficiently. When operations are completed more quickly, less bandwidth is wasted on waiting for data to be acknowledged or retransmitted, and the organizational network can handle higher volumes of traffic.

Some embodiments of this disclosure may include some, all, or none of these advantages. These advantages and other features will be more clearly understood from the following detailed description taken in conjunction with the accompanying drawings and claims.

### BRIEF DESCRIPTION OF THE DRAWINGS

For a more complete understanding of embodiments of the disclosure and the potential advantages thereof, reference is now made to the following written description taken in conjunction with the accompanying drawings, in which:

FIG. 1 is a schematic diagram of a system, in accordance with an embodiment of the present disclosure; and

FIG. 2 illustrates an example flowchart of a method of the system of FIG. 1 for predicting and remedying network dependency anomalies.

### DETAILED DESCRIPTION OF THE DRAWINGS

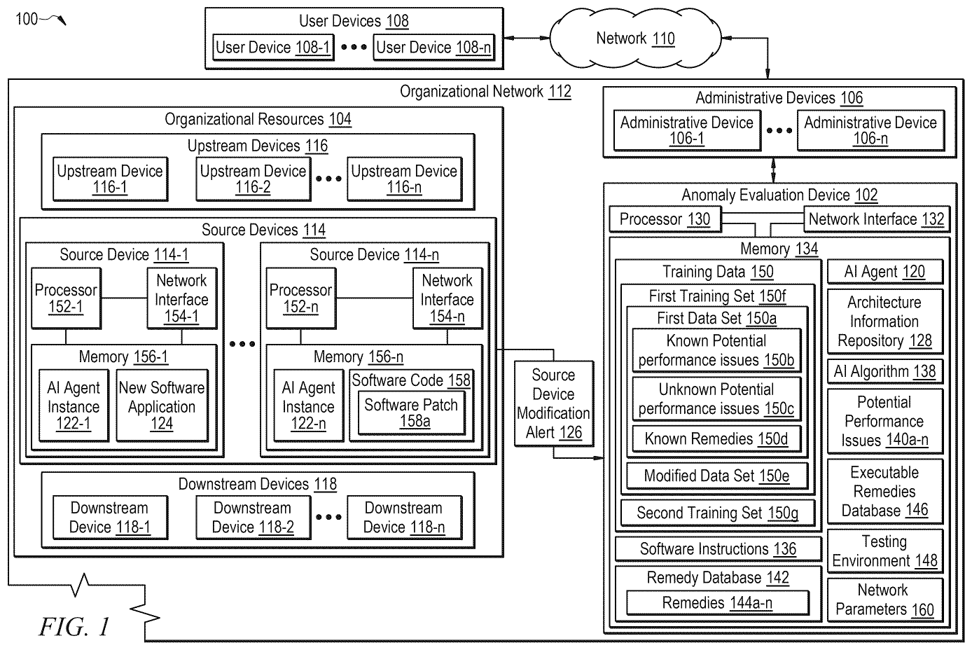

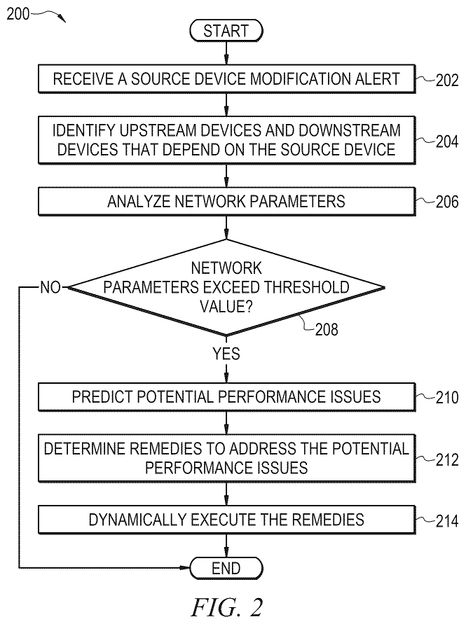

As described above, conventional technologies fail to provide reliable network communications between the organizational resources of an organization network. Embodiments of the present disclosure and its advantages may be understood by referring to FIGS. 1-2. FIGS. 1-2 is used to describe systems and methods for predicting and remedying network dependency anomalies, according to some embodiments.

### SYSTEM OVERVIEW

FIG. 1 is a schematic diagram of a system 100, in accordance with certain aspects of the present disclosure. As shown, system 100 includes an anomaly evaluation device 102, organizational resources 104, administrative devices 106-1 to 106-n, and user devices 108-1 to 108-n operably connected to one another and communicating via a network 110. Network 110 enables communication among the components of the system 100. In other embodiments, system 100 may include other elements instead of, or in addition to, those listed above. The anomaly evaluation device 102 and the organizational resources 104 are part of an organizational network 112. The organizational resources 104 include source devices 114-1 to 114-n, upstream devices 116-1 to 116-n, and downstream devices 118-1 to 118-n.

The administrative devices 106-1 to 106-n are collectively also referred to as the administrative devices 106. The user devices 108-1 to 108-n are collectively also referred to as the user devices 108. The source devices 114-1 to 114-n are collectively also referred to as the source devices 114. The upstream devices 116-1 to 116-n are collectively also referred to as the upstream devices 116. The downstream devices 118-1 to 118-n are collectively also referred to as the downstream devices 118.

In general, the working of system 100 is initiated by monitoring the source devices 114 for any modifications performed on them. For example, source device 114-1 may include an AI agent instance 122-1 (i.e., a software instance of the AI agent 120) that monitors the source device 114-1 and determines that a modification is performed on the source device 114-1. In this example, the modification performed on the source device 114-1 is an installation of a new software application 124 on the source device 114-1. Upon determining that the new software application 124 is installed on the source device 114-1, the AI agent instance 122-1 transmits a source device modification alert 126 to the anomaly evaluation device 102. Upon receiving the source device modification alert 126, the anomaly evaluation device 102 accesses an architecture information repository 128 and identifies a first set of upstream devices (e.g., the upstream devices 116-1 and 116-2) from the upstream devices 116 and a first set of downstream devices (e.g., downstream devices 118-1 and 118-2) from the downstream devices 118. The operations of the upstream devices 116-1 and 116-2 and the downstream devices 118-1 and 118-2 depend on the new software application 124 installed on the source device 114-1. Next, the anomaly evaluation device 102 predicts a potential performance issue 140a (of the plurality of potential performance issues 140a-n) associated with the operations performed by the upstream device 116-1 and the downstream device 118-1. For example, the potential performance issue 140a (i.e., an anomaly) may include an increased server load capacity of the upstream device 116-1 and the downstream device 118-1 because of additional operations corresponding with the new software application 124. Because of the increased server load capacity, the upstream device 116-1 and the downstream device 118-1 are unable to perform their operations. The anomaly evaluation device 102 determines one or more remedies 144a-n to address the potential performance issue 140a associated with the upstream device 116-1 and the downstream device 118-1. Further, anomaly evaluation device 102 dynamically executes the remedy 144a to address the potential performance issue 140a. For example, the remedy 144a includes adding additional upstream devices 116 (e.g., upstream device 116-n) to the first set of upstream devices (e.g., the upstream devices 116-1 and 116-2) and adding downstream devices 118 (e.g., downstream device 118-n) to the first set of downstream devices (e.g., downstream devices 118-1 and 118-2). Additionally, the anomaly evaluation device 102 includes an AI agent 120 that, when executed by processor 130, predicts potential performance issues 140a-n and their corresponding remedies 144a-n.

Remedying the potential performance issue 140a results in avoiding any breakdown of operations associated with the upstream devices (e.g., the upstream devices 116-1 and 116-2) and downstream devices (e.g., downstream devices 118-1 and 118-2) caused by an increase in server load capacity because of installing the new software application 124 at the source device 114-1.

### SYSTEM COMPONENTS

### Organizational Network

The organizational network 112 includes organizational resources 104, the anomaly evaluation device 102, and administrative devices 106 associated with an organization. The organizational network 112 is in communication with user devices 108 via network 110. In some embodiments, the organizational network 112 may be an internal network of the organization and may include all or a portion of a private data network, a local area network (LAN), a metropolitan area network (MAN), a wide area network (WAN), a local or regional communication or computer network, wireline or wireless network, an enterprise intranet, or any other suitable communication link, including combinations thereof, operable to facilitate communication between anomaly evaluation device 102, organizational resources 104, and administrative devices 106.

### Organizational Resources

The organizational resources 104 include source devices 114, upstream devices 116, and downstream devices 118. The organizational resources 104 of the system 100 of the present disclosure include hardware, such as mainframes, servers, databases, networking equipment, computers, mobile devices, memory devices, and the like; software that is executed by the hardware; and/or information stored or operated upon by the hardware or software. The source devices 114, upstream devices 116, and downstream devices 118 may generally be any device configured to process data. Additionally, administrative devices 106 may also include but are not limited to, a personal computer, a desktop computer, a workstation, a server, a laptop, a tablet computer, a mobile phone (such as a smartphone), an Internet-of-Things (IoT) device, or any other suitable type of device. The administrative devices 106 may include a user interface, such as a display, a microphone, a camera, a keypad, or other appropriate terminal equipment usable by a user. In an embodiment, source devices 114, upstream devices 116, and downstream devices 118 may be database servers, application servers, or any other server devices utilized within an organization.

### Anomaly Evaluation Device

The anomaly evaluation device 102 includes a processor 130 and a network interface 132 in signal communication with a memory 134. Memory 134 stores software instructions 136 that when executed by processor 130, cause processor 130 to perform one or more operations of the anomaly evaluation device 102 described herein.

### Processor

Processor 130 includes one or more processors. Processor 130 is any electronic circuitry, including, but not limited to, state machines, one or more central processing unit (CPU) chips, logic units, cores (e.g., a multi-core processor), field-programmable gate arrays (FPGAs), application-specific integrated circuits (ASICs), or digital signal processors (DSPs). For example, one or more processors are configured to execute instructions (e.g., software instructions 136) to perform the operations of the anomaly evaluation device 102 described herein. The processor 130 is configured to operate as described in FIGS. 1-2. For example, processor 130 may be configured to perform one or more operations of method 200 as described in FIG. 2.

### Network Interface

The network interface 132 may include an NFC interface, a Bluetooth® interface, a Zigbee® interface, a Z-wave® interface, a radio-frequency identification (RFID®) interface, a WIFI® interface, a local area network (LAN) interface, a wide area network (WAN) interface, a metropolitan area network (MAN) interface, a personal area network (PAN) interface, a wireless PAN (WPAN) interface, a modem, a switch, and/or a router. Network interface 132 is configured to enable wired and/or wireless communications. The network interface 132 may be configured to communicate data between the anomaly evaluation device 102 and other devices, systems, or domains. The processor 130 may be configured to send and receive data using the network interface 132. The network interface 132 may be configured to use any suitable type of communication protocol.

### Memory

The memory 134 may be volatile or non-volatile and may comprise read-only memory (ROM), random-access memory (RAM), ternary content-addressable memory (TCAM), dynamic random-access memory (DRAM), and static random-access memory (SRAM). The memory 134 may include one or more of a local database, a cloud database, a network-attached storage (NAS), etc. The memory 134 comprises one or more disks, tape drives, or solid-state drives and may be used as an over-flow data storage device to store programs when such programs are selected for execution and to store instructions and data that are read during program execution. Memory 134 may store any of the information described in FIGS. 1-2 along with any other data, instructions, logic, rules, or code operable to implement the function(s) described herein when executed by processor 130. For example, memory 134 may store an architecture information repository 128, AI agent 120, software instructions 136, an AI algorithm 138, potential performance issues 140a-n, a remedy database 142, executable remedies database 146, a testing environment 148, training data 150, network parameters 160, and/or any other data or instructions. The software instructions 136 may include any suitable set of instructions, logic, rules, or code operable to execute the processor 130 and perform the functions described herein, such as some or all of those described in FIGS. 1-2.

### Network

Network 110 may be any suitable type of wireless and/or wired network. The network 110 may be connected to the Internet or public network. Network 110 may include all or a portion of an Intranet, a peer-to-peer network, a switched telephone network, a local area network (LAN), a wide area network (WAN), a metropolitan area network (MAN), a personal area network (PAN), a wireless PAN (WPAN), an overlay network, a software-defined network (SDN), a virtual private network (VPN), a mobile telephone network (e.g., cellular networks, such as 4G or 5G), a plain old telephone (POT) network, a wireless data network (e.g., Wireless Fidelity (WiFi®), Wireless Gigabit (WiGig®), Worldwide Interoperability for Microwave Access (WiMAX®), etc.), a long-term evolution (LTE) network, a universal mobile telecommunications system (UMTS) network, a peer-to-peer (P2P) network, a Bluetooth® network, a near-field communication (NFC) network, and/or any other suitable network. The network 110 may be configured to support any suitable type of communication protocol, as would be appreciated by one of ordinary skills in the art. The organizational network 112 and the user devices 108 communicate with each other using the network 110.

### Initiate the Prediction of Potential Performance Issues

In a first stage, system 100 initiates the prediction of potential performance issues 140a-n (i.e., anomalies) by training an AI algorithm 138 to generate a trained AI algorithm 138 (also referred to as trained AI model 138). The trained AI algorithm 138 is then utilized by the AI agent 120. Specifically, the AI agent 120 is a software program that is configured by the processor 130 to utilize the trained AI model 138 to identify (i.e., predict) the potential performance issues 140a-n and their corresponding remedies 144a-n. In the second stage, the processor 130 executes the AI agent 120 to initiate the prediction of the potential performance issues 140a-n, and remedies 144a-n for the potential performance issues 140a-n. The first stage is explained in detail below.

### First Stage: Training the AI Algorithm and AI Agent

Processor 130 executes the AI agent 120 (i.e., an autonomous software program) to perform operations of predicting potential performance issues 140a-n and their corresponding remedies 144a-n. Specifically, the AI agent 120 is generated based on the AI algorithm 138. Processor 130 executes the training of the AI algorithm 138 to generate a trained AI algorithm 138 (also referred to as trained AI model 138). This trained AI model 138 is the foundation of the AI agent 120, providing the analytical and predictive capabilities. Processor 130 then utilizes the trained AI model 138 to generate the AI agent 120. The AI agent 120 is a software program that leverages the trained AI model 138 to interact with the organizational resources 104 to perform tasks autonomously, such as predicting potential performance issues 140a-n and its corresponding remedies 144a-n. Specifically, the AI agent 120 is a software program that is configured by the processor 130 to utilize the trained AI model 138 to identify (i.e., predict) the potential performance issues 140a-n and their corresponding remedies 144a-n.

The artificial intelligence (AI) algorithm 138 is trained using training data 150. The training data 150 includes two data sets. The first data set 150a and a modified first data set 150e. Processor 130 is configured to access the memory 134 to collect the first data set 150a stored in the memory 134. The first data set 150a includes the known potential performance issues 150b, unknown potential performance issues 150c, and known remedies 150d associated with the corresponding known potential performance issues 150b identified over a past period of time. Processor 130 is configured to create a modified first data set 150e by annotating each of the known potential performance issues 150b. The annotations indicate a corresponding known remedies 150d associated with the known potential performance issues 150b. Processor 130 creates a first training set 150f which includes the first data set 150a and the modified first data set 150e. The AI algorithm 138 is trained in a first stage using the first training set 150f. Further, processor 130 is configured to create a second training set 150g for a second stage of training. The second training set 150g includes the first training set 150f and any incorrectly determined known potential performance issues 150b corresponding to known remedies 150d. Processor 130 re-trains the AI algorithm 138 in a second stage using the second training set 150g to create a trained AI algorithm 138. The trained AI algorithm 138 is also referred to as the trained AI model 138. Processor 130 then utilizes the trained AI model 138 to generate the AI agent 120. The AI agent 120 is a software program that is configured by the processor 130 to utilize the trained AI model 138 to identify (i.e., predict) the potential performance issues 140a-n and their corresponding remedies 144a-n.

The AI algorithm 138 may include a support vector machine, machine learning, neural network, random forest, a large language model (LLM) algorithm, deep learning algorithm, k-means clustering, Tree-based algorithm, Random Forest algorithm, convolutional neural network (CNN), deep neural network (DNN), recurrent neural network (RNN), Naïve Bayes classification, etc. In some embodiments, the AI algorithm 138 may include a data processing machine learning algorithm. The AI algorithm 138 may be implemented by supervised, semi-supervised, and/or unsupervised machine learning. In another embodiment, processor 130 executes the AI algorithm 138 to predict the potential performance issues 140a-n and their corresponding remedies 144a-n. In another embodiment, processor 130 executes software instructions 136 and is configured to predict the potential performance issues 140a-n and their corresponding remedies 144a-n without utilizing AI algorithm 138. In another embodiment, processor 130 executes the AI agent 120 to utilize the AI algorithm 138 to predict the potential performance issues 140a-n and their corresponding remedies 144a-n. In another embodiment, processor 130 executes software instructions 136 and is configured to predict the potential performance issues 140a-n and their corresponding remedies 144a-n without utilizing AI agent 120. Here, the first stage is completed.

In the second stage, the processor 130 executes the AI agent 120 to initiate the prediction of the potential performance issues 140a-n, and remedies 144a-n for the potential performance issues 140a-n. As part of the second stage of predicting potential performance issues 140a-n, the system 100 utilizes an AI agent instance 122-1 to monitor the source devices 114 for any modifications performed on them.

### Second Stage: Monitoring of Source Devices

The source devices 114-1 to 114-n are monitored for any modifications performed on them. For example, source device 114-1 includes a processor 152-1 and a network interface 154-1 in signal communication with a memory 156-1. Memory 156-1 stores AI agent instance 122-1. Processor 152-1 executes the AI agent instance 122-1 to perform monitoring of the source device 114-1. The AI agent instance 122-1 is a software instance of the AI agent 120, such that the AI agent instance 122-1 has a specific function of monitoring the source device 114-1 and determining if a modification is performed on the source device 114-1. For example, the modification performed on the source device 114-1 may be an installation of a new software application 124 on the source device 114-1. Upon determining that the new software application 124 is installed on the source device 114-1, the AI agent instance 122-1 transmits a source device modification alert 126 to the anomaly evaluation device 102.

Similar to source device 114-1, source device 114-n includes a processor 152-n and a network interface 154-n in signal communication with a memory 156-n. Memory 156-n stores AI agent instance 122-n and software code 158. Processor 152-n executes the AI agent instance 122-n to monitor the source device 114-n. For example, AI agent instance 122-n monitors the source device 114-n to determine if a modification is performed on the source device 114-n. In another embodiment, the modification performed on the source device 114-n may be updating a portion of the software code 158 by including a software patch 158a (i.e., updated software code) of the source device 114-n.

In another embodiment, the processor 130 of the anomaly evaluation device 102 monitors the source devices 114 without utilizing AI agent instances 122-1 to 122-n. The processor 130 of the anomaly evaluation device 102 may be configured to monitor the source devices 114 at certain time periods to determine if any modifications are performed on the source devices 114. The time periods may include every 24 hours, 1hour, or 1 minute, although any other time period may also be included.

### Receiving Source Device Modification Alert

The anomaly evaluation device 102 receives the source device modification alert 126 from the AI agent instance 122-1. The source device modification alert 126 is an alert message that provides a source device identifier that identifies the source device 114-1 that is being modified. The source device modification alert 126 also includes modification information about the modification being performed. For example, modification information about the modification being performed may indicate the installation of a new software application 124 or updating a portion of the software code 158.

Upon receiving the source device modification alert 126, the processor 130 executes the AI agent 120 of the anomaly evaluation device 102 to access architecture information repository 128 and identify a first set of upstream devices (e.g., the upstream devices 116-1 and 116-2) from the upstream devices 116 and a first set of downstream devices (e.g., downstream devices 118-1 and 118-2) from the downstream devices 118 based on the source device identifier included in the source device modification alert 126. The architecture information repository 128 stores the dependency information associated with the upstream devices 116 and the downstream devices 118 corresponding to each source device identifier of the source devices 114. For example, the dependency information associated with source device identifier of source device 114-1 includes upstream devices 116-1 and 116-2 and downstream devices 118-1 and 118-2 as being dependent on source device 114-1 to perform their operations. In another example, the dependency information associated with source device 114-n includes upstream devices 116-2 and 116-n and downstream devices 118-2 and 118-n as being dependent on source device 114-n to perform their operations.

### Analyze Network Parameters

Upon identifying the first set of upstream devices (e.g., the upstream devices 116-1 and 116-2) and the first set of downstream devices (e.g., downstream devices 118-1 and 118-2), the processor 130 executes the AI agent 120 to analyze network parameters 160 associated with the identified the upstream devices 116-1 and 116-2 and downstream devices 118-1 and 118-2. The network parameters 160 may include server load capacity associated with the upstream devices 116-1 and 116-2 and downstream devices 118-1 and 118-2, application programming interface (API) call logs associated with the upstream devices 116-1 and 116-2 and downstream devices 118-1 and 118-2, or energy consumption (i.e., power supply required to operate devices) associated with the upstream devices 116-1 and 116-2 and downstream devices 118-1 and 118-2.

The AI agent 120 is trained to identify which of the network parameters 160 are to be analyzed based on the modification information included in the source device modification alert 126. For example, in an embodiment, when the modification information indicates the installation of a new software application 124, then AI agent 120 is trained to analyze server load capacity associated with the upstream devices 116-1 and 116-2 and downstream devices 118-1 and 118-2. In this example, the upstream devices 116-1 and 116-2 and the downstream devices 118-1 and 118-2 are server devices. Further, the processor 130 executes the AI agent 120, which analyzes, for example, the network parameter 160 of server load capacity associated with upstream devices 116-1 and 116-2 and downstream devices 118-1 and 118-2. The server load capacity is the maximum number of operations (i.e., a threshold value) a server device can perform without degrading its performance. In other words, if a server device exceeds its server load capacity, then the server device will be unable to perform its operations efficiently. For example, for the network parameter of server load capacity, the threshold value is 85% of the total server load capacity of a server device.

In another embodiment, when the modification information indicates the updating of a portion of the software code 158, then the AI agent 120 is trained to analyze application programming interface (API) call logs associated with the upstream devices 116-1 and 116-2 and the downstream devices 118-1 and 118-2. In yet another embodiment, when the modification information indicates the installation of a new software application 124, then AI agent 120 is trained to analyze energy consumption (i.e., power supply required to operate devices) associated with the upstream devices 116-1 and 116-2 and downstream devices 118-1 and 118-2.

### Predict Potential Performance Issues

Upon analyzing the network parameters 160 associated with the first set of upstream devices (e.g., the upstream devices 116-1 and 116-2) and the first set of downstream devices (e.g., downstream devices 118-1 and 118-2), the processor 130 executes the AI agent 120 to determine if the modification performed (i.e., installation of new software application 124) on the source device 114-1 would lead to potential performance issues 140a-n.

For example, in response to the analysis, the AI agent 120 predicts that the server load capacity of upstream device 116-1 would be 90% of its total capacity and of upstream device 116-2 would be 50% of its total capacity in response to the modification performed (i.e., installation of new software application 124) on the source device 114-1. Similarly, AI agent 120 predicts that the server load capacity of downstream device 118-1 would be 95% of its total capacity and of downstream device 118-2 would be 40% of its total capacity in response to the modification performed (i.e., installation of new software application 124) on the source device 114-1. Next, the processor 130 executes the AI agent 120 to compare the predicted server load capacity for each of the upstream devices 116-1 and 116-2 and the downstream devices 118-1 and 118-2 with the threshold value of the total server load capacity. For example, for the network parameter of server load capacity, the threshold value is 85% of the total server load capacity of a server device. Based on the comparison, the AI agent 120 determines that the upstream device 116-1 and downstream device 118-1 have server load capacities of 90% and 95%, respectively, and thus both the upstream device 116-1 and downstream device 118-1 would exceed the threshold value of 85%. This would result in the upstream device 116-1 and downstream device 118-1 being unable to perform their operations. Thus, the AI agent 120 predicts a potential performance issue 140a (of the plurality of potential performance issues 140a-n) of the upstream device 116-1 and downstream device 118-1 being unable to perform their operations, based on server load capacities of the upstream device 116-1 and downstream device 118-1 exceeding the threshold value.

### Determine Remedies to Address the Potential Performance Issue

In response to predicting the potential performance issues 140a-n, the processor 130 executes the AI agent 120 to access the remedy database 142 to determine, for example, a remedy 144a from the remedies 144a-n to address the potential performance issue 140a associated with the upstream device 116-1 and downstream device 118-1. The AI agent 120 accesses the remedy database 142, which stores a plurality of remedies 144a-n corresponding to each potential performance issue 140a-n. For example, for the potential performance issue 140a of the upstream device 116-1 and the downstream device 118-1 being unable to perform their operations, the AI agent 120 determines remedy 144a to address the potential performance issue 140a.

### Dynamically Execute the Remedies

In response to determining remedies 144a-n, the processor 130 executes the AI agent 120 to address the potential performance issues 140a-n associated with the upstream devices 116 and the downstream devices 118.

For example, upon determining remedy 144a to address the potential performance issue 140a, the AI agent 120 dynamically executes the remedy 144a. The dynamic execution of remedy 144a includes adding additional upstream devices 116 (e.g., upstream device 116-n) as part of the dependency information associated with source device 114-1 along with upstream devices 116-1 and 116-2 to perform their operations in response to the modification performed (i.e., installation of new software application 124) on the source device 114-1. By adding the additional upstream device 116-n as part of the dependency information associated with source device 114-1, the additional operations associated with the modification performed (i.e., installation of new software application 124) on the source device 114-1 is now divided to be performed by the additional upstream device 116-n along with the upstream devices 116-1 and 116-2, thus reducing the server load capacity of the upstream device 116-1, for example from 90% to 50%. Thus, remedying the potential performance issue 140a associated with the upstream device 116-1.

Similarly, dynamic execution of remedy 144a also includes adding downstream devices 118 (e.g., downstream device 118-n) as part of the dependency information associated with source device 114-1 along with downstream devices 118-1 and 118-2 to perform their operations in response to the modification performed (i.e., installation of new software application 124) on the source device 114-1. By adding the additional downstream device 118-n as part of the dependency information associated with source device 114-1, the additional operations associated with the modification performed (i.e., installation of new software application 124) on the source device 114-1 is now divided to be performed by the additional downstream device 118-n along with the downstream devices 118-1 and 118-2, thus reducing the server load capacity of the downstream device 118-1, for example from 95% to 55%. Thus, remedying the potential performance issue 140a associated with the downstream device 118-1.

By predicting potential performance issues 140a-n and executing remedies 144a-n to address the predicted potential performance issues 140a-n before the performance of the upstream devices 116 and downstream devices 118 are affected results in avoiding any breakdown of operations associated with the upstream devices (e.g., the upstream device 116-1) and downstream devices (e.g., downstream devices 118-1) caused by an increase in server load capacity because of installing the new software application 124 at the source device 114-1. This further avoids increasing network latency associated with the operations of the organizational network 112. Lowering the latency associated with performing operations in the organizational network 112 improves network performance and computing performance in several ways and results in several technical advantages. For example, lower latency means operations associated with the organizational resources 104 are completed more quickly. This results in faster processing and data exchange across the organizational network 112.

In an embodiment, in response to determining the remedy 144a to address the potential performance issue 140a associated with the upstream device 116-1 and the downstream device 118-1 in response to the installation of a new software application 124 on the source device 114-1, the AI agent 120 is configured to determine if the remedy 144a is included in the executable remedies database 146. The executable remedies database 146 stores a list of remedies that are executable by the AI agent 120. When the AI agent 120 determines that the remedy 144a is included in the executable remedies database 146, the AI agent 120 dynamically executes the remedy 144a (as explained above). Additionally, the AI agent 120 is configured to transmit a remedy notification to the administrative devices 106. The remedy notification indicates that the remedy 144a is being executed by the AI agent 120 to address the potential performance issue 140a. Further, when the AI agent 120 determines that the remedy 144a is not included in the executable remedies database 146, the AI agent 120 is configured to transmit a remedy notification to the administrative devices 106. The remedy notification indicates that the remedy 144a cannot be executed by the AI agent 120 and is to be addressed manually by the administrative devices 106.

### Modification at the Source Device 114-n is Updating a Portion of the Software Code

In an embodiment, similar to source device 114-1, source device 114-n includes a processor 152-n and a network interface 154-n in signal communication with a memory 156-n. Memory 156-n stores AI agent instance 122-n and software code 158. Processor 152-n executes the AI agent instance 122-n to monitor the source device 114-n. For example, AI agent instance 122-n monitors the source device 114-n to determine if a modification is performed on the source device 114-n. In another embodiment, the modification performed on the source device 114-n may be updating a portion of the software code 158 by including a software patch 158a (i.e., updated software code) of the source device 114-n. Upon determining that the software code 158 is updated with a software patch 158a on the source device 114-n, the AI agent instance 122-n transmits a source device modification alert 126 to the anomaly evaluation device 102. The source device modification alert 126 includes the source device identifier associated with source device 114-n and modification information that indicates the updating of a portion of the software code 158 by including a software patch 158a.

Similar to source device 114-1 and as explained above, when the anomaly evaluation device 102 receives the source device modification alert 126 from source device 114-n, it includes the source device identifier associated with source device 114-n. The processor 130 executes the AI agent 120 of the anomaly evaluation device 102 to access the architecture information repository 128 and identifies the upstream device 116-2 and downstream device 118-2 as being dependent on the source device 114-1 to perform their operations. Next, based on the modification information that indicates the updating of a portion of the software code 158 by including a software patch 158a, the AI agent 120 is trained to analyze API call logs associated with the upstream device 116-2 and the downstream device 118-2. The API call logs provide information about the time duration associated with completing operations corresponding to the software code 158. For example, the API call log associated with the upstream device 116-2 may indicate that an operation A performed by upstream device 116-2 takes a time duration of three seconds to be completed. For example, upstream device 116-2 performs the operation A in association with user device 108-1.

Next, in response to analyzing the API call logs associated with the upstream device 116-2, the AI agent 120 compares the time duration to perform operation A with a threshold value. This threshold value indicates a threshold time period within which the operation A is to be performed to meet a predefined service level agreement associated with user device 108-1. For example, the threshold value for operation A is one second. In response to determining that the time duration of three seconds associated with upstream device 116-2 exceeds the required threshold value of 1 second, and thus AI agent 120 determines that operation A is not being performed at an optimal satisfactory level to meet the predefined service level agreement. The operation A not being performed at an optimal satisfactory level to meet the predefined service level agreement would lead to breakdown of certain future operations also associated with upstream device 116-2 that rely on operation A. This would cause the upstream device 116-2 to be unable able to perform current (e.g., operation A) and future operations that dependent on operation A. Thus, AI agent 120 is able to predict potential performance issues (e.g., potential performance issue 140b) associated with upstream device 116-2 because the software patch 158a is incompatible with the upstream device 116-2.

Another API call log associated with the downstream device 118-2 may indicate that an operation B performed by downstream device 118-2 takes a time duration of 5 seconds to be completed. Additionally, in response to analyzing the API call logs associated with the downstream device 118-2, the AI agent 120 compares the time duration to perform operation B with another threshold value. This threshold value indicates a threshold time period within which the operation B is to be performed to meet a predefined service level agreement. For example, the threshold value for operation B is two seconds. In response to determining that the time duration of five seconds associated downstream device 118-2 exceeds the required threshold value of two second, and thus AI agent 120 determines that operation B is not being performed at an optimal satisfactory level to meet the predefined service level agreement. The operation B not being performed at an optimal satisfactory level to meet the predefined service level agreement would lead to breakdown of certain future operations also associated with downstream device 118-2 that rely on operation B. This would cause the downstream device 118-2 to be unable able to perform current (e.g., operation B) and future operations that dependent on operation B. Thus, AI agent 120 is able to predict potential performance issues (e.g., potential performance issue 140c) associated with downstream device 118-2 because the software patch 158a is incompatible with the downstream device 118-2.

In response to the AI agent 120 predicting the potential performance issues (e.g., potential performance issue 140b and potential performance issue 140c) associated with the upstream device 116-2 and the downstream device 118-2, the AI agent 120 determines remedies (e.g., remedy 144b from the remedies 144a-n) to address the potential performance issues (e.g., potential performance issue 140b and potential performance issue 140c) associated with the first upstream device and the first downstream device based on accessing the remedy database 142. In this example, remedy 144b addresses potential performance issue 140b and potential performance issue 140c.

Next, the AI agent 120 dynamically executes the remedy 144b to address the potential performance issue 140b and the potential performance issue 140c. For example, remedy 144b is to remove the software patch 158a included in the software code 158 to generate a sanitized version of the software code 158 without the software patch 158a. By removing or deleting the software patch 158a the upstream device 116-2 and downstream device 118-2 would be able to continue to perform their operations without interruptions thus remedying the potential performance issue 140b and the potential performance issue 140c. This results in avoiding a breakdown of operations associated with the upstream device 116-2 and downstream device 118-2 caused by updating software code 158 with the software patch 158a that is incompatible with the upstream device 116-2 and downstream device 118-2.

### Isolated Testing Environment

In an embodiment, AI agent 120 is configured to dynamically execute the remedies 144a-n (for example, remedy 144b) in a testing environment 148. The testing environment 148 is also referred to as an isolated testing environment 148. The isolated testing environment 148 is included in a portion of the memory 134 that is an isolated memory sector. In other words, the isolated testing environment 148 is stored in an isolated memory sector, and any operations performed within the testing environment 148 are isolated from the rest of the memory 134. Additionally, the isolated testing environment 148 is isolated from the organizational resources, including the source devices 114, the upstream devices 116, and the downstream devices 118. The AI agent 120 is configured to dynamically execute, for example, remedy 144b in this isolated testing environment 148 to determine if the potential performance issue 140b and potential performance issue 140c are remedied. For example, the AI agent 120 executes the remedy 144b by storing a copy of the software code 158 with the software patch 158a in the isolated testing environment 148. Next, the AI agent 120 removes the software patch 158a included in the software code 158 to generate a sanitized version of the software code 158 without the software patch 158a. The AI agent 120 then performs testing of this sanitized version of the software code 158 without the software patch 158a to determine if the potential performance issue 140b and potential performance issue 140c are remedied.

In response to determining that the potential performance issue 140b and potential performance issue 140c are remedied in the isolated testing environment 148, the AI agent 120 dynamically executes the remedies 144a-n on at least one of the source devices 114, upstream devices 116, or downstream devices 118. In this example, the AI agent 120 dynamically executes the remedy 144a on the software code 158 stored on the source device 114-n to remove the software patch 158a included in the software code 158 to generate a sanitized version of the software code 158 without the software patch 158a.

In response to determining that potential performance issue 140b is not remedied in the isolated testing environment 148, the AI agent 120 transmits a remedy notification to administrative devices 106. The remedy notification that the remedy 144b does not address the potential performance issue 140b and potential performance issue 140b is to be addressed manually by the administrative devices 106.

### Hardware Performance Issues and Software Performance Issues

The predicted potential performance issues 140a-n may include potential hardware performance issues or potential software performance issues. In an embodiment, hardware performance issues may include the AI agent 120 predicting a potential performance issue 140a (also referred to as potential hardware performance issue 140a) in response to the installation of a new software application 124 on the source device 114-1. The potential performance issue 140a is associated with the upstream device 116-1 and downstream device 118-1 being unable to perform their operations, based on server load capacities of the upstream device 116-1 and downstream device 118-1 exceeding the threshold value. Further, in an embodiment, potential software performance issues may include the AI agent 120 predicting the potential performance issue 140b (also referred to as potential software performance issue 140b) and potential performance issue 140c (also referred to as potential software performance issue 140c) associated with the upstream device 116-2 and the downstream device 118-2 in response to updating of a portion of the software code 158 by including a software patch 158a. Additionally, the AI agent 120 is configured to determine a remedy 144a (as explained above) for the potential hardware performance issue 140a, and the AI agent 120 is configured to determine a remedy 144b (as explained above) for potential software performance issue 140b and potential software performance issue 140c.

FIG. 2 illustrates an example flowchart of method 200 for predicting and remedying network dependency anomalies, in accordance with an embodiment of the present disclosure. For example, one or more operations of method 200 may be implemented, at least in part, in the form of software instructions 136 of FIG. 1, stored on a tangible non-transitory machine-readable medium or a computer-readable medium (e.g., memory 134 of FIG. 1) that, when run by one or more processors (e.g., processor 130 of FIG. 1) may cause the one or more processors to perform operations of the method 200.

Referring to FIG. 2, at operation 202, processor 130 of anomaly evaluation device 102 receives the source device modification alert 126 from the AI agent instance 122-1 stored at source device 114-1.

At operation 204, the processor 130 executes the AI agent 120 of the anomaly evaluation device 102 to access architecture information repository 128 and identify a first set of upstream devices (e.g., the upstream devices 116-1 and 116-2) from the upstream devices 116 and a first set of downstream devices (e.g., downstream devices 118-1 and 118-2) from the downstream devices 118 based on the source device identifier included in the source device modification alert 126.

At operation 206, the processor 130 executes the AI agent 120 to analyze network parameters 160 associated with the identified upstream devices 116-1 and 116-2 and downstream devices 118-1 and 118-2. The processor 130 executes the AI agent 120, which analyzes, for example, the network parameter 160 of server load capacity associated with upstream devices 116-1 and 116-2 and downstream devices 118-1 and 118-2.

At operation 208, the processor 130 executes the AI agent 120 to perform a comparison to determine if the predicted server load capacity for each of the upstream devices 116-1 and 116-2 and the downstream devices 118-1 and 118-2 exceeds the threshold value of the total server load capacity. For example, for the network parameter of server load capacity, the threshold value is 85% of the total server load capacity of a server device. Based on the comparison, the AI agent 120 determines that the upstream device 116-1 and downstream device 118-1 have server load capacities of 90% and 95%, respectively, and thus both the upstream device 116-1 and downstream device 118-1 would exceed the threshold value of 85%. In response to determining that the predicted server load capacity for each of the upstream devices 116-1 and 116-2 and the downstream devices 118-1 and 118-2 exceeds the threshold value of the total server load capacity, the method proceeds to operation 210.

At operation 210, the processor 130 executes the AI agent 120 determines since predicted server load capacity for each of the upstream devices 116-1 and 116-2 and the downstream devices 118-1 and 118-2 exceeds the threshold value of the total server load capacity, thus upstream device 116-1 and downstream device 118-1 being unable to perform their operations. Thus, the AI agent 120 predicts a potential performance issue 140a (of the plurality of potential performance issues 140a-n) of the upstream device 116-1 and downstream device 118-1 being unable to perform their operations.

At operation 212, the processor 130 executes the AI agent 120 to access the remedy database 142 to determine, for example, a remedy 144a from the remedies 144a-n to address the potential performance issue 140a associated with the upstream device 116-1 and downstream device 118-1.

At operation 212, the processor 130 executes the AI agent 120 to dynamically execute the remedy 144a to address the potential performance issue 140a. The dynamic execution of remedy 144a includes adding additional upstream devices 116 (e.g., upstream device 116-n) as part of the dependency information associated with source device 114-1 along with upstream devices 116-1 and 116-2 to perform their operations in response to the modification performed (i.e., installation of new software application 124) on the source device 114-1. The method ends here.

Back at operation 208, based on the comparison, when the AI agent 120 determines that each of the upstream devices 116-1 and 116-2 and the downstream devices 118-1 and 118-2 have server load capacities that do not exceed the threshold value of 85%, then the method proceeds to operation 216, and the method ends here.

While several embodiments have been provided in the present disclosure, it should be understood that the system 100 and methods might be embodied in many other specific forms without departing from the spirit or scope of the present disclosure. The present examples are to be considered as illustrative and not restrictive, and the intention is not to be limited to the details given herein. For example, the various elements or components may be combined or integrated with another system or certain features may be omitted, or not implemented. In addition, techniques, systems, subsystems, and methods described and illustrated in the various embodiments as discrete or separate may be combined or integrated with other systems, modules, techniques, or methods without departing from the scope of the present disclosure. Other items shown or discussed as coupled or directly coupled or communicating with each other may be indirectly coupled or communicating through some interface, device, or intermediate component whether electrically, mechanically, or otherwise. Other examples of changes, substitutions, and alterations are ascertainable by one skilled in the art and could be made without departing from the spirit and scope disclosed herein. To aid the Patent Office, and any readers of any patent issued on this application in interpreting the claims appended hereto, applicants note that they do not intend any of the appended claims to invoke 35 U.S.C. § 112(f), as it exists on the date of filing hereof, unless the words “means for” or “step for” are explicitly used in the particular claim.

What is claimed is:

1. A system comprising:
a memory operable to store an artificial intelligence (AI) algorithm and an architecture information repository, wherein the architecture information repository stores dependency information associated with one or more upstream devices and one or more downstream devices corresponding with a source device; and
a processor operably coupled to the memory and configured to:
collect a first data set comprising known potential performance issues, unknown potential performance issues, and known remedies associated with the corresponding known potential performance issues stored in the memory;
create a modified first data set by annotating each of the known potential performance issues, wherein the annotations indicate a known remedy associated with the known potential performance issue;
create a first training set comprising the first data set and the modified first data set;
train the AI algorithm in a first stage using the first training set;
create a second training set for a second stage of training, wherein the second training set comprises the first training set and incorrectly determined known potential performance issues corresponding to known remedies;
retrain the AI algorithm in a second stage using the second training set, to generate an AI agent;
electronically receive a source device modification alert from a first instance of the AI agent installed at the source device, wherein the first instance of the AI agent is configured to monitor the source device for any modifications performed on the source device and wherein the source device modification alert indicates an installation of a new software application on the source device; and
in response to receiving a source device modification alert, execute the AI agent to:
identify the one or more upstream devices and the one or more downstream devices that depend on the new software application installed on the source device, wherein the one or more upstream devices and the one or more downstream devices are identified based at least in part upon accessing the architecture information repository that stores the dependency information associated with the one or more upstream devices and the one or more downstream devices corresponding with the source device;
analyze one or more network parameters associated with the one or more upstream devices and the one or more downstream devices;
in response to analyzing the one or more network parameters, predict one or more potential performance issues associated with operations performed by a first upstream device of the one or more upstream devices and a first downstream device of the one or more downstream devices, wherein the one or more potential performance issues includes unable to perform the operations associated with the first upstream device and the first downstream device;
in response to predicting the one or more potential performance issues associated with the first upstream device and the first downstream device, determine one or more remedies to address the one or more potential performance issues associated with the first upstream device and the first downstream device; and
dynamically execute the one or more remedies to address the one or more potential performance issues associated with the first upstream device and the first downstream device.

2. The system of claim 1, wherein the processor is further configured to execute the AI agent to:
in response to dynamically executing the one or more remedies, transmit a remedy notification to one or more administrative user devices, wherein the remedy notification indicates the one or more remedies are being executed to address the one or more potential performance issues.

3. The system of claim 1, wherein the one or more network parameters includes a server load capacity associated with the one or more upstream devices and the one or more downstream devices or application programming interface (API) call logs associated with the one or more upstream devices and the one or more downstream devices.

4. The system of claim 1, wherein the processor is further configured to execute the AI agent to:
dynamically execute the one or more remedies in an isolated testing environment to determine if the one or more potential performance issues are remedied, wherein the isolated testing environment is isolated from the source device, the one or more upstream devices and the one or more downstream devices; and
in response to determining that one or more potential performance issues are remedied in the isolated testing environment, dynamically execute the one or more remedies to address the one or more potential performance issues associated with the first upstream device and the first downstream device.

5. The system of claim 4, wherein the processor is further configured to execute the AI agent to:
in response to determining that one or more potential performance issues are not remedied in the isolated testing environment, transmit a remedy notification to one or more administrative user devices, wherein the remedy notification includes the one or more remedies to address the one or more potential performance issues.

6. The system of claim 1, wherein one or more potential performance issues includes a potential hardware performance issue or a potential software performance issue.

7. The system of claim 6, wherein the one or more remedies includes a remedy for the potential hardware performance issue or a remedy for the potential software performance issue.

8. A method comprising:
collecting a first data set comprising known potential performance issues, unknown potential performance issues, and known remedies associated with the corresponding known potential performance issues stored in a memory;
creating a modified first data set by annotating each of the known potential performance issues, wherein the annotations indicate a known remedy associated with the known potential performance issue;
creating a first training set comprising the first data set and the modified first data set;
training an artificial intelligence (AI) algorithm in a first stage using the first training set;
creating a second training set for a second stage of training, wherein the second training set comprises the first training set and incorrectly determined known potential performance issues corresponding to known remedies;
retraining the AI algorithm in a second stage using the second training set, to generate an AI agent;
electronically receiving a source device modification alert from a first instance of an AI agent installed at a source device, wherein the first instance of the AI agent is configured to monitor the source device for any modifications performed on the source device and wherein the source device modification alert indicates an installation of a new software application on the source device;
in response to receiving a source device modification alert, identifying one or more upstream devices and one or more downstream devices that depend on the new software application installed on the source device, wherein the one or more upstream devices and the one or more downstream devices are identified based at least in part upon accessing an architecture information repository that stores dependency information associated with the one or more upstream devices and the one or more downstream devices corresponding with the source device;
analyzing one or more network parameters associated with the one or more upstream devices and the one or more downstream devices;
in response to analyzing the one or more network parameters, predicting one or more potential performance issues associated with operations performed by a first upstream device of the one or more upstream devices and a first downstream device of the one or more downstream devices, wherein the one or more potential performance issues includes unable to perform the operations associated with the first upstream device and the first downstream device;
in response to predicting the one or more potential performance issues associated with the first upstream device and the first downstream device, determining one or more remedies to address the one or more potential performance issues associated with the first upstream device and the first downstream device; and
dynamically executing the one or more remedies to address the one or more potential performance issues associated with the first upstream device and the first downstream device.

9. The method of claim 8, further comprising:
in response to dynamically executing the one or more remedies, transmitting a remedy notification to one or more administrative user devices, wherein the remedy notification indicates the one or more remedies are being executed to address the one or more potential performance issues.

10. The method of claim 8, wherein the one or more network parameters includes a server load capacity associated with the one or more upstream devices and the one or more downstream devices or application programming interface (API) call logs associated with the one or more upstream devices and the one or more downstream devices.

11. The method of claim 8, further comprising:
dynamically executing the one or more remedies in an isolated testing environment to determine if the one or more potential performance issues are remedied, wherein the isolated testing environment is isolated from the source device, the one or more upstream devices and the one or more downstream devices; and
in response to determining that one or more potential performance issues are remedied in the isolated testing environment, dynamically executing the one or more remedies to address the one or more potential performance issues associated with the first upstream device and the first downstream device.

12. The method of claim 11, further comprising:
in response to determining that one or more potential performance issues are not remedied in the isolated testing environment, transmitting a remedy notification to one or more administrative user devices, wherein the remedy notification includes the one or more remedies to address the one or more potential performance issues.

13. The method of claim 8, wherein one or more potential performance issues includes a potential hardware performance issue or a potential software performance issue.

14. The method of claim 13, wherein the one or more remedies includes a remedy for the potential hardware performance issue or a remedy for the potential software performance issue.

15. A system comprising:
a memory operable to store an architecture information repository, wherein the architecture information repository stores dependency information associated with one or more upstream devices and one or more downstream devices corresponding with a source device; and
a processor operably coupled to the memory and configured to:
determine a modification performed on the source device, wherein the modification performed on the source device includes an installation of a new software application on the source device;
in response to determining the modification performed on the source device, identify the one or more upstream devices and the one or more downstream devices that depend on the new software application installed on the source device, wherein the one or more upstream devices and the one or more downstream devices are identified based at least in part upon accessing the architecture information repository that stores the dependency information associated with the one or more upstream devices and the one or more downstream devices corresponding with the source device;
analyze one or more network parameters associated with the one or more upstream devices and the one or more downstream devices;
in response to analyzing the one or more network parameters, predict one or more potential performance issues associated with operations performed by a first upstream device of the one or more upstream devices and a first downstream device of the one or more downstream devices, wherein the one or more potential performance issues includes unable to perform the operations associated with the first upstream device and the first downstream device;
in response to predicting the one or more potential performance issues associated with the first upstream device and the first downstream device, determine one or more remedies to address the one or more potential performance issues associated with the first upstream device and the first downstream device; and
dynamically execute the one or more remedies to address the one or more potential performance issues associated with the first upstream device and the first downstream device.

16. The system of claim 15, wherein the processor is further configured to:
in response to dynamically executing the one or more remedies, transmit a remedy notification to one or more administrative user devices, wherein the remedy notification indicates the one or more remedies are being executed to address the one or more potential performance issues.

17. The system of claim 15, wherein the one or more network parameters includes a server load capacity associated with the one or more upstream devices and the one or more downstream devices or application programming interface (API) call logs associated with the one or more upstream devices and the one or more downstream devices.

18. The system of claim 15, wherein the processor is further configured to:
dynamically execute the one or more remedies in an isolated testing environment to determine if the one or more potential performance issues are remedied, wherein the isolated testing environment is isolated from the source device, the one or more upstream devices and the one or more downstream devices; and
in response to determining that one or more potential performance issues are remedied in the isolated testing environment, dynamically execute the one or more remedies to address the one or more potential performance issues associated with the first upstream device and the first downstream device.

19. The system of claim 18, wherein the processor is further configured to:
in response to determining that one or more potential performance issues are not remedied in the isolated testing environment, transmit a remedy notification to one or more administrative user devices, wherein the remedy notification includes the one or more remedies to address the one or more potential performance issues.

20. The system of claim 15, wherein one or more potential performance issues includes a potential hardware performance issue or a potential software performance issue.
